(19) United States
(12) Patent Application Publication
(10) Pub. No.: US 2012/0158229 A1
(43) Pub. Date: Jun. 21, 2012

(54) ELECTRIC VEHICLE HAVING A GPS BASED GAS STATION RESERVATION FUNCTION

(75) Inventor: Tim Schaefer, Niedersachswerfen (DE)

(73) Assignee: LI-TEC BATTERY GMBH, Kamenz (DE)

(21) Appl. No.: 13/263,119

(22) PCT Filed: Mar. 31, 2010
(86) PCT No.: PCT/EP10/02070

§ 371 Date: Mar. 6, 2012

(30) Foreign Application Priority Data
Apr. 8, 2009 (DE) 10 2009 016 869.9

(51) Int. Cl. B60L 11/18; H01M 10/48; H02J 7/00

(52) U.S. Cl. 701/22; 320/109; 429/91

(57) ABSTRACT

The invention relates to a method for operating a vehicle which comprises an electric travel drive and at least one rechargeable and replaceable electric power unit, the electric travel drive being supplied with electric drive energy by the electric power unit and the electric power unit being recharged or replaced when its charge status is low.

Priority application DE 10 2009 016 869.9 is fully incorporated by reference into the present application.

The present invention relates to a method for operating a vehicle, a navigation device, a vehicle energy control system, a supply station and an infrastructure for supplying such vehicles with electric energy as well as a suitable electric power unit.

It is known to use electric current to drive vehicles, in particular cars and boats. The electric current is carried on board the vehicle in batteries or storage batteries (in everyday language, storage batteries also widely referred to as batteries in the vehicle sector) and is used via an electric motor for the drive. Lithium-ion batteries have become established in recent years as a high-capacity and powerful basis for electric vehicle drive systems.

In principle, the majority of electric vehicles can be charged at any socket. The network of public battery charging stations for electric vehicles requires however, even in a massive expansion stage to be expected in the future, long charging times; in the case of longer journeys, this requires careful route and time planning. Irrespective of the range of the vehicles, relatively long charging breaks have in particular to be allowed for. Even a light electric mobile with a low current consumption, such as for example the vehicle known under the trade name TWIKE, requires according to the manufacturer's specifications, depending on the battery version, between 1 and 3 hours for a complete charge (95%) at a charging station with conventional 3.5 kW (230 V/16 A). Electric vehicles with a higher performance and battery capacity require correspondingly longer a charging times.

The situation can be somewhat alleviated by power sockets, if the batteries and their charging systems are suitably designed. The Park&Charge System of public electric filling stations for solar mobiles and E-mobiles, which have arisen in recent years in Switzerland, delivers as standard 3.5 kW or 10 kW, for example, depending on the design and fuse protection. If, however, vehicles with a long range are to be charged in future within a reasonable time, correspondingly higher connection values will need to be provided, which could quickly stretch the limits of the network capacity. Furthermore, such a quick charging procedure represents a high load on a battery and, depending on the type of battery, can permanently limit its useful life.

Another concept is pursued by so-called loan systems, which relate to the vehicle as a whole or to the battery or modules thereof. Such a concept is pursued, for example, by the town of Stuttgart with battery replacement stations for Pedelecs (electric bicycles) at stopping points of public local passenger transport (Spiegel Online, 3, Jun. 2008, 11:33, “Stuttgart plant Elektrofahrrad Netzwerk”, www.spiegel.de/auto/aktuell/0,1518,556352,00.html)). The ambitious project “better place” of the company Shai Agassi provides for a region-wide network of electric filling stations with charging and replacement stations (manager-magazin.de, 30, Oct. 2007, “Das SAP Wunderkind kehrt zurück”, www.manager-magazin.de/it/artikel/0,2828,514273,00.html). Here, battery replacement stations are provided, which hold batteries of many types in stock and in which a battery can be replaced in a short time.

The further introduction and prevalence of electric vehicles is still however encountering obstacles. Thus, for example, there is in some cases the fear of being left stranded with an empty battery during the journey. This fear is based on the following expectation. An empty tank of a motor vehicle with an internal combustion engine is admittedly an inconvenience, but with the aid of a breakdown service, a spare can or perhaps just a tube and a helpful motorist, it can comparatively easily be overcome. In contrast, the recharging or replacement of an empty battery is more difficult on an open stretch of road. A replacement on an open stretch of road calls for a high transport outlay on account of the great weight of a powerful battery, and it is not certain whether the notified breakdown service will have the required type of battery in stock. The rendering of help by other road users is virtually limited to being towed. In the case of electric vehicles, therefore, it is far more important than in the case of motor vehicles to be able reliably to reach the next suitable filling station or supply station.

Navigation systems have already become known, wherein information concerning the location of filling stations is stored and used. This information alone, however, is insufficient in the case of electric drives. On account of the lower energy density of electric power units (batteries) compared to conventional fuels and the consequently increased requirement for storage volume, and on account of the possible diversity of types in the case of batteries, an adequate supply reliability requires a higher logistic outlay than in the case of conventional fuels. It is therefore necessary to operate a mix of recharging, redistribution between supply stations and local charging of batteries with a flexible approach to the ongoing exit of fully charged batteries and entry of empty or partially empty batteries at the supply stations. If it should happen that no fully charged units are available at a type suitable in itself for recharging and in particular for replacement of batteries just at the time when they are required, the only option for the driver of the vehicle is time-consuming recharging and therefore a forced wait at the supply station. This is particularly inconvenient in the case of fully automatic stations with no accommodation facilities, especially in otherwise thinly populated and climatically unfavourable regions.

The aforementioned fear acquires particular importance from the standpoint of safety on water, in particular on fairly large lakes or in sea areas close to the coast. If a boat or ship is operated electrically on a fairly large stretch of water, such as for example Lake Constance or other lakes, it is important always to remain within range of a charging or battery replacement station in order not to inadvertently end up in an emergency at sea. On the other hand, it is an inconvenience constantly to remain in the vicinity of supply stations due to excessive caution, without this specifically being necessary.

The problem underlying the present invention, therefore, is to provide a power supply method, a vehicle control system, a supply station and an infrastructure, an electric power unit and a route-finding method and navigation device, with which a suitable filling station or supply station can reliably be reached.

The problem is solved by the features of the dependent claims. Advantageous developments of the invention are the subject-matter of the sub-claims.

According to the invention, a method for operating a vehicle, which comprises an electric travel drive and at least one rechargeable and replaceable electric power unit, wherein electric drive energy is fed from the electric power unit to the electric travel drive and wherein the electric power unit is charged or replaced when its charge status is low, comprises the following steps:
determination of a charge status of the electric power unit;
determination of a current position of the vehicle;
calculation of a range of the vehicle on the basis of the charge status of the electric power unit;
determination of a given stock level of supply stations which are equipped for the recharging and/or the replacement of the electric power unit, wherein the stock level is defined at least by the number and charge status of electric power units held in stock in a supply station; and
determination of at least one of the supply stations as a suitable supply station, if the supply station lies within the range of the vehicle and the stock level of the supply station meets a predetermined condition, in particular a predetermined number of charged electric power units are available for replacement,
wherein, in order to calculate the range and/or to determine suitable supply stations, essential data are communicated between the vehicle and at least one of the supply stations and/or between the vehicle and a control centre and/or between the supply stations and the control centre, wherein at least the communication between the vehicle and the supply stations and/or the control centre takes place in a wireless manner.

With the method, a journey with the vehicle can be planned and conducted in such a way that a suitable supply station with an adequate number of charged batteries can reliably be reached. The possibility of being left stranded on an open stretch of road can be avoided. The invention is advantageously characterised in that the data required to calculate the range and/or to determine suitable supply stations are communicated wireless between the vehicle and at least one of the supply stations and/or a control centre. In this way, it is possible for the required calculations, determinations and storage procedures to be carried out optionally centrally or in a decentralised manner or distributed over a plurality of computing entities in the control centre, the supply stations or the vehicles.

For this purpose, at least the position and current range of the vehicle can for example be broadcast, after which information is sent to the vehicle concerning suitable supply stations. In this case, the supply stations (or the control centre) bear the computational burden and supply the vehicle-supported system merely with the results of the determination. On the other hand, the stock level of a supply station can be broadcast within a predetermined surrounding area. The broadcast can then be picked up by vehicles located in the surrounding area and incorporated into their computational procedures for determining suitable supply stations.

In special circumstances, for example in the case of an unexpectedly high energy consumption during the journey or in the case of unexpected demand peaks at a supply station, it may be that there are no other adequately equipped supply stations available within the current range of the vehicle. It is then advantageous for a supply station, whose stock level does not meet the predetermined condition, to be alternatively designated as a suitable supply station if it is equipped to charge the electric power unit with a quick-charging procedure. A possible loss of time during charging can thus be kept within limits.

If need be, a supply station, at which the stock level does not meet the predetermined condition and which is not equipped for charging the electric power unit with a quick-charging procedure, can then to be designated alternatively as a suitable supply station if it is in principle equipped for charging the electric power unit. Such a supply station can then reasonably be taken into account if it lies at the destination of the journey, since it can be assumed that a certain amount of parking time is in any case planned there.

A destination selectable by the user is preferably taken as a basis for the determination as a suitable supply station or the supply stations determined as suitable are weighted on the basis of the selected destination. The suitable supply stations can thus be selected based on the destination, whereas supply stations leading away from the destination can be ignored.

If the suitable supply station located farthest from the present position of the vehicle in the direction of the destination is determined as the target supply station, taking account of a predetermined safety reserve, the capacity of the electric power unit can be utilised optimally.

According to the proposed method, a travel route can be calculated from the present position of the vehicle to the destination on the basis of suitable supply stations and the method can thus be incorporated into the routine of a navigation system known per se. Preferably, the suitable supply station located farthest from the present position of the vehicle on the calculated travel route is determined as the target supply station, taking account of a predetermined safety reserve, in order to utilise the capacity of the electric power unit in the optimum manner.

The method can be constituted still more flexibly if the user is offered suitable supply stations on the travel route for selection or rejection.

Optimisation of the route finding can be achieved by the iterative implementation of the steps of calculating a travel route and determining suitable supply stations, preferably including the step of determining a target supply station and the step of offering and selection or rejection.

It is possible to reserve a required number of electric power units for a vehicle at a supply station, if the supply station has been determined as a suitable supply station for this vehicle, the reservation preferably taking place on the basis of a specific request from the vehicle. It can thus be ensured that a supply station once determined as suitable has the required number of (charged) electric power units upon arrival of the vehicle.

It is advantageous if the specific request to a specific supply station is made dependent on a confirmation by a user of the vehicle. Incorrect reservations can thus be avoided if the user of the vehicle prefers a different route or a different pattern of breaks. If a supply station is the only suitable supply station within reach, a reservation can be made regardless of a confirmation by the user.

In order to calculate the range, use may be made of at least one of the criteria of a currently measured speed of the vehicle, a previous speed and/or acceleration profile, energy consumption parameters of the vehicle, charging and discharging characteristics of the electric power unit, driver data, such as for example preferred driving behaviour, road data along the travel route, weather information and traffic information. The energy requirement to be expected for a route can thus be estimated with sufficient accuracy depending on the requirement. It is thus possible to utilise the range of the vehicle and of the electric power unit in the optimum manner with an adequate safety reserve. This also increases the flexibility of the electric drive and the popularity of the drive and supply concept, since it safeguards the user against the energy supply surprisingly running out.

In order to calculate the range, a plurality of alternative speed profiles can also be extrapolated on the basis of varied parameters. Such variations can provide the user of the vehicle with information concerning driving behaviour to the adhered to in order to reach one or another supply station, or in particular to produce energy-saving travel routes.

The establishment of the suitability or non-suitability of a supply station is preferably continuously repeated during the vehicle's journey, in order to be able always to take account of the current and changing conditions. It is thus also possible to reach a suitable supply station reliably even when changes in the suitability of a supply station arise and the charge status of the electric power unit falls more quickly than expected during the journey.

In particular, it is possible to check continuously whether a suitable supply station can be reached on the currently adopted travel route. If this is not the case, countermeasures can be taken. These countermeasures can be limited merely to informing the user, but can also include specific calculations for variations or suggestions for action.

The steps of the method can, to a varying extent, be carried out centrally or distributed so as to be undertaken by the vehicle, by one or more of the supply stations and/or by an administrative control centre, in order to be able to comply with the requirements of operational safety, data protection, computational burden, storage requirement, power consumption etc.

In a further development of the method, the travel routes of all the vehicles participating in the method can be conducted dynamically on the basis of the routes previously selected and notified by the given user and defined by starting point and destination, in such a way that the travel time and/or the total energy consumption of the vehicles are optimised.

According to one aspect of the invention, the method described above is carried out in a navigation device.

The present invention can be embodied in a vehicle energy control system for controlling an energy supply for a vehicle, which comprises an electric travel drive and at least one rechargeable and replaceable electric power unit, wherein electric drive energy is fed from the electric power unit to the electric travel drive and wherein the electric power unit is recharged or replaced when its charge status is low. The vehicle energy control system comprises at least one position locating device for locating a position of the vehicle and a charge status determination device for determining a charge status of the electric power unit. According to various aspects of the invention, the vehicle energy control system further comprises:
a range calculation device for calculating a range of the vehicle on the basis of the charge status of the electric power unit determined by the charge status determination device; a reception device for the wireless reception of information from a wireless remote communication network concerning supply stations which are equipped for the charging and/or the replacement of the energy storage unit and concerning their given stock level, wherein the stock level is defined at least by the number and charge status of electric power units held in stock in a supply station; and a suitability determination device for determining a supply station as a suitable supply station when the supply station lies within the range of the vehicle and its stock level meets a predetermined condition, in particular such that a predetermined number of charged electric power units is available for replacement, or
a memory device, in which identification data of the electric power unit and preferably of the vehicle, and/or charging/discharging parameters of the electric power unit and/or energy consumption parameters of the vehicle are previously stored; a transmission device for the wireless transmission of information, which contains the position, the charge status of the electric power unit, the identification data of the electric power unit and optionally of the vehicle, the charging/discharging parameters of the electric power unit and the energy consumption parameters of the vehicle, to a remote communication network; a reception device for the wireless reception of information from the remote communication network concerning the present range of the vehicle and concerning supply stations which are within the range of the vehicle and which are equipped and suitable for the charging and/or the replacement of the electric power unit, wherein only the supply stations are determined as suitable whose stock level meets a predetermined condition, in particular such that a predetermined number of charged electric power units is available for replacement,

The aforementioned aspects can also be implemented jointly.

With such a vehicle energy control system, the method described above can be carried out to a varying extent by the vehicle, or more precisely the electric power unit, and the required data can be communicated to a remote, optionally central, entity for further processing. The transmitted and received data can contain additional information, depending on the distribution of the computational burden.

For the implementation of partial aspects of the method with the vehicle energy control system, it is advantageous if a navigation device is present for ascertaining a travel route from the present position of the vehicle to a destination selectable by the user.

The navigation device can make available route data, such as height profile, curve characteristics, lateral inclination, road surface and condition (in particular friction coefficients), speed restrictions, traffic density to be expected statistically, necessary stopping points or stopping points to be expected at crossroads, intersections, traffic lights, level crossings and suchlike, optionally taking account of the day of the week, holidays, holiday periods and time of day. In this way, it is possible to use route data for calculating the range.

Furthermore, a traffic information evaluation device can be provided for receiving and evaluating traffic information, which is made available by an administrative control centre or a radio transmitter. It is thus possible to use up-to-date traffic data to calculate the range.

Furthermore, a weather information evaluation device can be provided for receiving and evaluating weather information, which is made available by an administrative control centre or a radio transmitter, and/or a weather data detection device for detecting weather data such as temperature, light intensity, humidity, wet conditions, headwind, tailwind, side wind and suchlike. It is thus possible to use up-to-date and/or predicted weather data to calculate the range and the discharge to be expected and, if the vehicle is provided with a photovoltaic device, possible recharging by photovoltaically generated current.

The traffic information and/or the weather information can be received for example via a radio apparatus from a radio transmitter and can be made available in a suitable form for further processing.

A driving state detection device for detecting characteristic driving states such as speed, longitudinal acceleration, longitudinal deceleration, lateral acceleration, road adhesion or skidding and suchlike can also be provided. A driving state memory device for storing the characteristic driving states over the course of time is preferably provided. In this way, it is possible to use characteristic driving states, in particular in the previous course thereof, to calculate the range. In particular, this is possible by means of a driver behaviour evaluation device for determining parameters for describing typical driving behaviour of the present driver on the basis of the characteristic driving states in the course of time.

Depending on where and in which parts the individual steps of the method described above are carried out, the transmission device can be equipped to transmit, to the administrative control centre and/or the supply stations, route data made available by the navigation device and/or traffic information received from the traffic information evaluation device and/or weather data received from the weather information evaluation device or detected by the weather data detection device and/or driving states detected by the driving state detection device and/or driving state characteristics stored in the driving state memory device and/or behaviour parameters determined by the driver behaviour evaluation device. In this way, the data can be processed centrally and the computational burden can be taken over from the vehicle. The data-processing devices on board the vehicle can thus be simplified and designed in an energy-saving manner.

The present invention can also be embodied with electric energy in a supply station for supplying vehicles which comprises an electric travel drive and at least one rechargeable and preferably replaceable electric power unit. Such a supply station comprises: a storage facility for storing a plurality of electric power unit; at least one replacement facility for replacing electric power units located on board a vehicle with electric power units from the storage facility; at least one charging device for charging electric power units located on board a vehicle; a stock level determination device for determining a stock level of the supply station, defined by the number and charge status of the electric power units stored in the storage facility; and a communication device for exchanging data with vehicles in the surrounding area of the supply station and/or, via vehicles in the surrounding area of the supply station, with an administrative control centre.

Such supply stations are essential for performing the method described above. The method described above can be performed to a varying extent by the supply station and the required data can be communicated to the participating vehicles or optionally to a central entity for further processing.

The supply station is preferably equipped for handling a number of types of electric power unit. It goes without saying that the determination of the stock level is carried out separately for each type of electric power unit. Enquiries from vehicles with a special battery type can thus be answered specifically or stock level data can be processed in a filtered manner according to the type of battery at the location of the vehicles.

The communication device preferably transmits data indicating the stock level to the vehicles or the administrative control centre. In this case, the determination of the suitability or non-suitability of the supply station for the supply of a specific vehicle can take place in the vehicles themselves or in the administrative control centre. The communication device can send the data indicating the stock level only when it receives a stock level enquiry from a vehicle or from the administrative control centre.

Alternatively, the supply station can comprise a suitability determination device for determining whether the supply station is suitable for the supply of a vehicle on the basis of the ascertained stock level and the data concerning the vehicle received via the communication device, wherein the received data contains at least a position of the vehicle and a charge status of the electric power unit located on board the vehicle and the communication device then transmits data indicating the determined suitability or non-suitability of the supply station to the vehicles or to the administrative control centre.

Furthermore, a reservation device for reserving an electric power unit for a specific vehicle can be provided. This reservation device can carry out the steps of the method described above, related to a reservation or a cancellation thereof.

At least one charging device suitable for quick-charging can be present in the supply station. It is thus possible, even when a suitable electric power unit for a requesting vehicle is precisely not available at the supply station, for the waiting time for the charging to be kept within tolerable limits.

The supply station preferably comprises a storeroom charging device for the charging or charge regeneration of electric power units stored in the storage facility. The electric power units can thus be charged at the location of the supply station and the extent of the . . . [omission] . . . between the supply stations and a central storage and distribution point can be reduced. The charge regeneration takes place cyclically, since the energy is used more efficiently in this way than when the electric power units are subjected to permanent compensation charging. The charging can essentially take place when electric energy is available from the network, thus for example at night-time, and can thus contribute to the stabilisation of the network and to taking up excess capacities and peaks. Overall, the battery stock should be relatively stable in the storage facility. The permanent equipping of the storage facilities of a plurality of supply stations is guaranteed by appropriate logistics, which are secured by means of computing devices, control devices and communication devices.

The supply station can comprise an electric energy generation device for generating electric energy from fossils or reproductive raw materials or regenerative sources and preferably an electric energy intermediate storage unit for the intermediate storage of the generated electric energy until its use. The charging of the batteries can thus also be ensured independently of the network. On the other hand, electric energy produced in excess can be fed into the network and can thus be used in turn for stabilisation of the network in another direction, i.e. for covering demand peaks. Depending on the location, wind, sunlight, flowing water, changing of the tide, wave power or suchlike are also available as regenerative sources.

The present invention can also be embodied in an infrastructure for the supply of electric energy to vehicles which comprise an electric travel drive and at least one rechargeable and preferably replaceable electric power unit. Such an infrastructure comprises a plurality of the supply stations described above and a plurality of the vehicle energy control systems described above and, optionally, an administrative control centre which, interacting with one another, are equipped to perform the method described above.

A further aspect of the present invention relates to a rechargeable and replaceable electric power unit with a control unit for detecting and controlling operational states, including at least a charge status of the electric power unit, and a radio communication device for communicating with an entity outside the vehicle. Such an electric power unit can transmit data concerning its type and charge status directly to a supply station or an administrative control centre and can optionally receive data concerning suitable supply stations within reach (the communication can take place terrestrially via a radio network such as for example GMS or suchlike). In addition, identification data can be transmitted, which can be used in the administrative control centre to assign the electric power unit to a specific vehicle. Furthermore, the electric power unit can be equipped to ascertain a present position of the electric power unit, for example by means of a permanently fitted GPS receiver, or to evaluate position data of a navigation device carried on board the vehicle. If the radio communication device is equipped for direct communication with the radio communication devices of another electric power unit, all the batteries can communicate with one another and can control reservation requests with one another at this level; in addition, the radio communication devices can act as relays for communication with the supply stations, without the intervention of an external network. The electric power unit is preferably a battery based on an electrochemical reaction with the participation of lithium.

The aforementioned and other features, problems and advantages of the present invention will be seen more clearly from the following description of specific embodiments, which are provided with a reference to the appended drawings. In the figures:

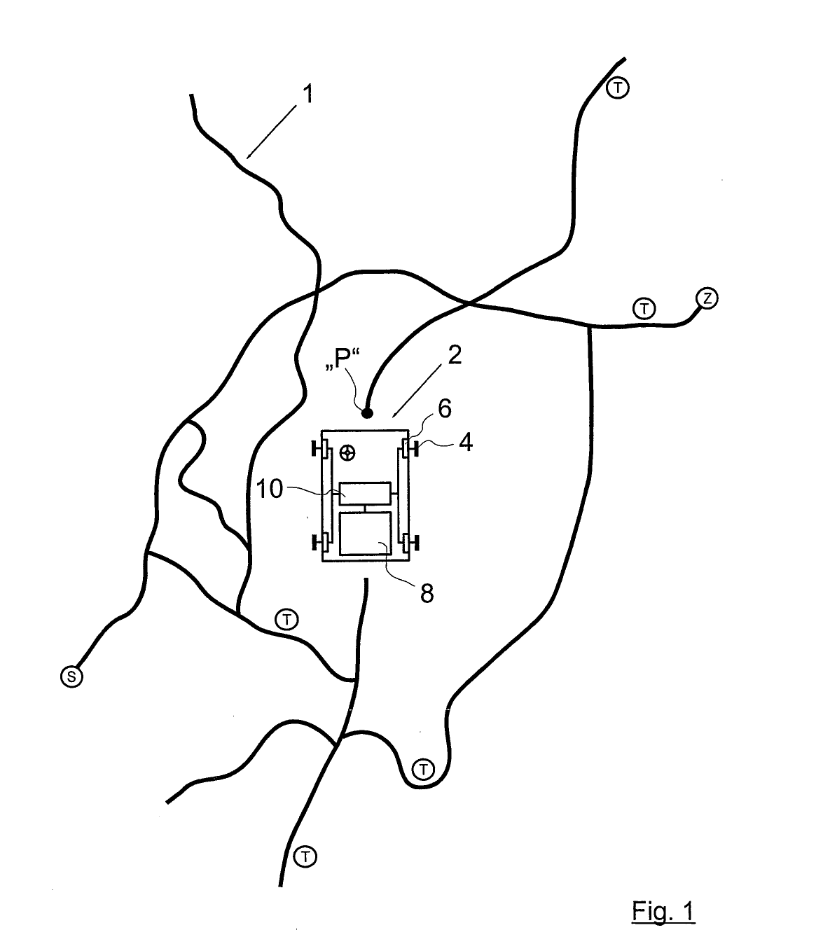

FIG. 1 shows a schematic representation of a road network with a vehicle;

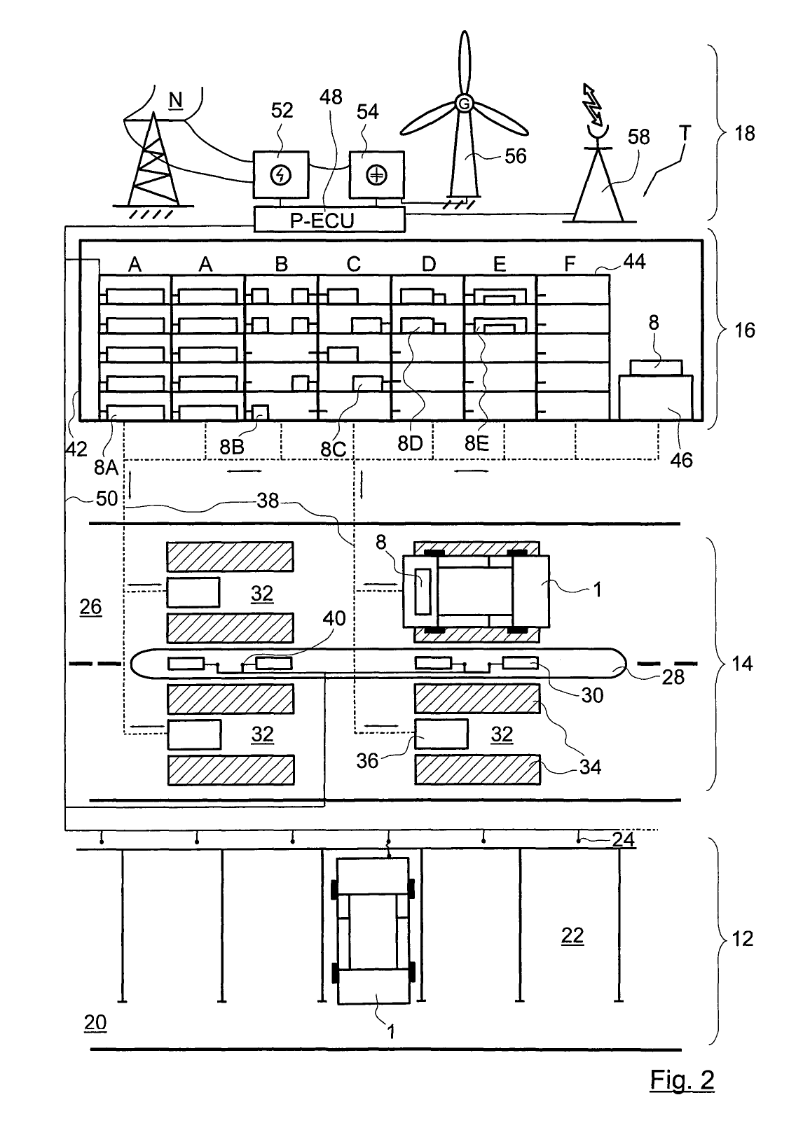

FIG. 2 shows a schematic representation of a filling station according to an embodiment of the invention;

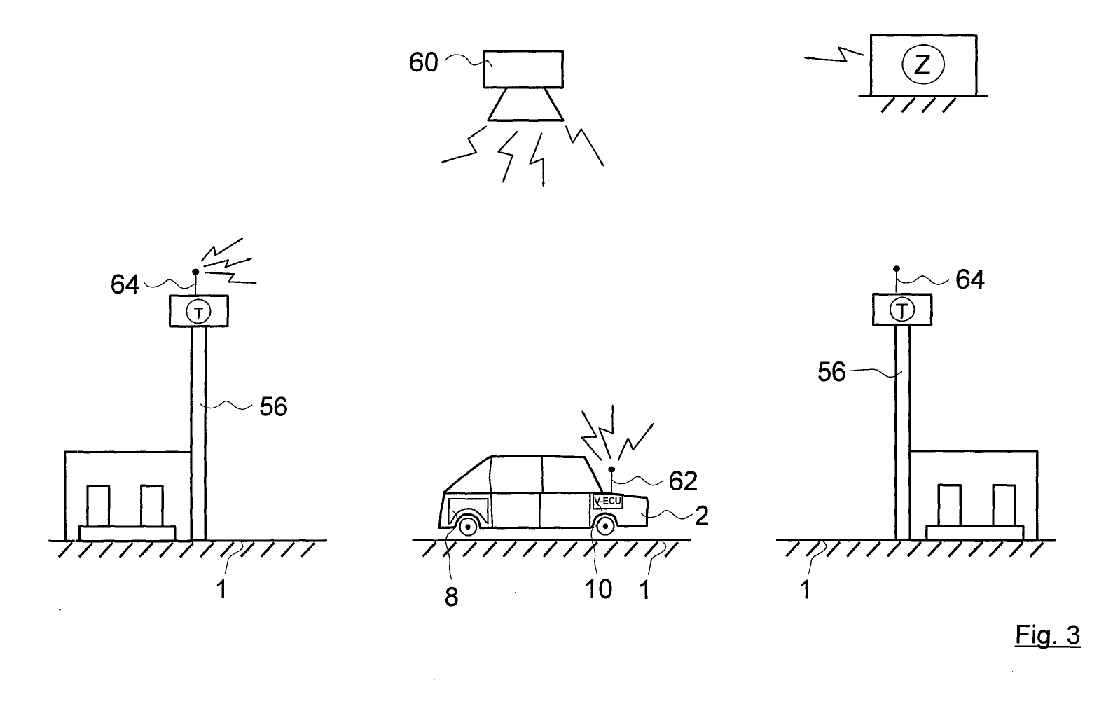

FIG. 3 shows a schematic representation of an infrastructure according to an embodiment of the invention;

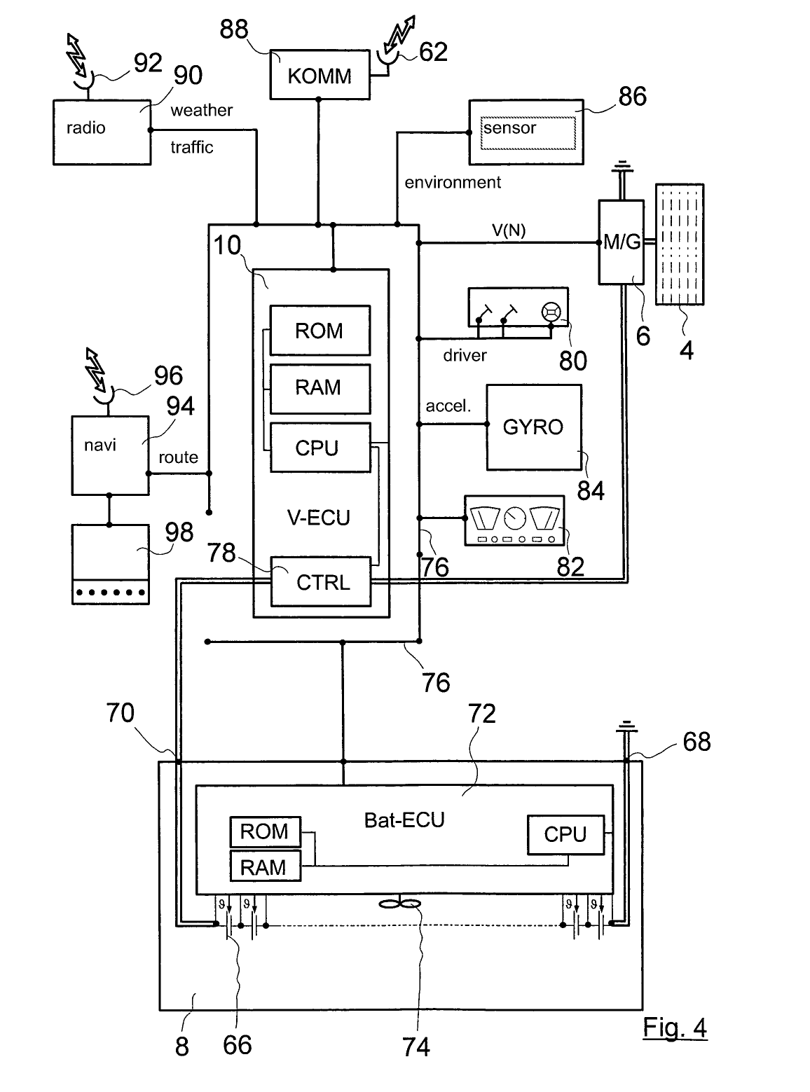

FIG. 4 shows a schematic representation of an energy management system of a vehicle according an embodiment of the invention;

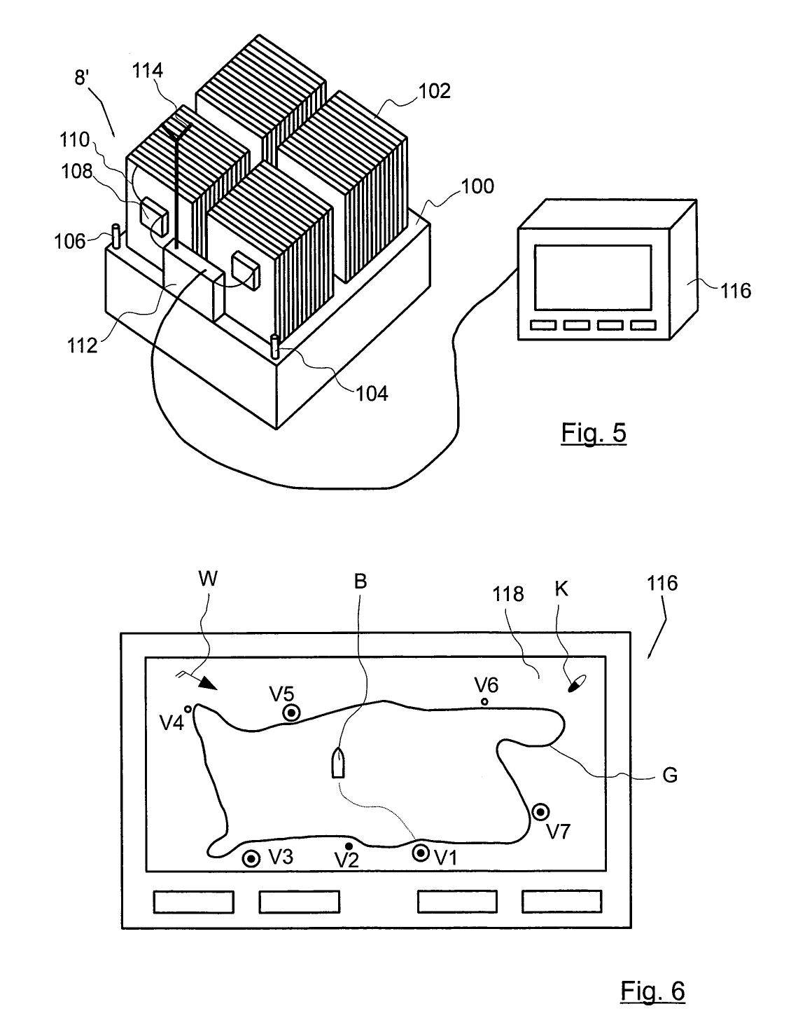

FIG. 5 shows a perspective representation of a battery unit according to an embodiment of the invention; and

FIG. 6 shows a schematic representation of a screen display on a display unit in FIG. 5.

It is pointed out that the representations in the figures are schematic and limited to the reproduction of the features most important for an understanding of the invention. It is also pointed out that the dimensions and size relations reproduced in the figures merely serve to make the representation clearer and are under no circumstances to be understood as limiting or imperative.

The present invention will now be described with the aid of specific embodiments.

FIG. 1 is a schematic representation of a road network 1 with a plurality of roads, crossroads, forks and intersections. A vehicle 2, which is also represented merely schematically, is located on one of the roads.

A plurality of filling stations “T” are located along the roads in road network 1. Filling stations T comprise battery charging stations and battery replacement stations, which will be explained in greater detail below; petrol pumps for fuels can also be provided there. A starting point “S” and a destination point “Z” of the journey of vehicle 2 are entered in the road network. The present position of vehicle 2 is marked by “P”.

According to the schematic representation in FIG. 1, vehicle 2 comprises four drive wheels 4, which are each driven by an electric motor 6. A battery or a storage battery (referred to in short below as “battery”) 8 supplies the electric energy for the drive, which is transmitted via a control device (V-ECU) 10 to electric motors 6.

The number of drive wheels and electric motors can be changed without affecting the invention. Thus, only two wheels of vehicle 2 can be drive wheels, and there can also be just one electric motor, the output moment whereof is distributed via a gear unit to the drive wheels.

Battery 8 is to be designed here as a lithium-ion battery. Battery types on a different electrochemical basis are however also conceivable, such as for example lead-gel batteries, nickel-cadmium batteries or others. It is also possible to provide two or more batteries.

Battery 8 is designed so as be replaceable. It can optionally be released manually as a module or can be removed or inserted automatically as a whole or in a modular manner. The contacting preferably takes place in a form-fit manner in a work step during the installation. Dangerous voltage levels are thus in principle avoided. Mechanical, electrical or other safety devices, for example in the contacting region of the module, are thereby also released, as a result of which battery 8 can not only be removed without danger from the system, but can also go for dispatch in accordance with the safety and transport regulations, e.g. if the battery part has been checked as defective by the charging station (see below).

Battery 8 is charged without a charging system being carried along, but it comprises at a modular level a suitable battery management system, which is operated by an overriding master and can be controlled via the energy management of the vehicle.

FIG. 2 shows diagrammatically the structure of a filling station according to the invention. Filling station T is split up into a charging zone 12, a replacement zone 14, a storage zone 16 and an energy management zone 18.

Charging zone 12 comprises an approach path 20 and a plurality of charging places 22. An automatic charger 24 is assigned to each charging place 22. Automatic charger 24 is constituted for example as a column or as a box or suchlike and comprises at least one socket for a charging cable or a permanently installed charging cable. Automatic chargers 24 designed for quick-charging with a high output, but can also manage low charging outputs for more careful charging. If a vehicle 2 is located on a charging place 22, its battery or the charging management system is connected via a cable to respective automatic charger 24. The type of charging procedure at automatic charger 24 is selected according to the type of battery or is automatically determined. A direct payment procedure in cash or by cheque or credit card directly at automatic charger 24 or a separate cash desk can be undertaken, or charging via a subscription account can take place on the basis of a user identification carried out at automatic charger 24.

Replacement or exchange zone 14 comprises a twin-track access path 26 and a service pylon 28. A total of four automatic service machines 30 are disposed on service pylon 28. Automatic service machines 30 are each assigned to one of four replacement places 32, which are provided on both sides of service pylon 28. (In a modification, just one automatic service machine 30 can be provided for a plurality of replacement places 32.)

Each replacement place 32 comprises two standing tracks 34 and a replacement pit 36. Replacement pit 36 is disposed below ground and, when no vehicle is located on replacement place 32, it can be closed for safety reasons by means of a drop-down or sliding door (not represented in detail). For the exchange of a battery, vehicle 2 is moved onto standing tracks 34 of a free replacement place 32. Located in replacement pit 36 is a robot (not represented in detail), which removes battery 8 of the vehicle from below, after it has detached fastenings, connections and, where appropriate, covers, and is transported to storage zone 16 by means of a conveyor 38. From there, a fresh battery 8 is transported into replacement pit 36, also by means of conveyor 38, and is installed in vehicle 2 by means of the robot.

Standing tracks 34 here are merely markings painted on the ground. In a modification, standing tracks 34 can however also comprise a conveying arrangement for positioning vehicle 2 on replacement place 32, as is known per se, for example from car washes. By means of such a conveying arrangement, the vehicle can be automatically positioned for the exchange procedure.

Automatic service machines 30 have a number of functions. An operator can carry out an identification here and confirm a replacement procedure. Furthermore, payment can be made here. Automatic service machine 30 also indicates the progress or success or failure of the identification and replacement procedure.

In the event that a replacement procedure is unsuccessful, a charging connection 40 is also disposed on service pylon 28 for each replacement place 32. Charging connections 40 are controlled via automatic service machines 30. In contrast with automatic chargers 24 in the charging zone, only quick-charging procedures are possible with charging connections 40 in replacement zone 14, in order that replacement place 32 is not occupied for too long.

A compartment rack 44 and a testing area 46 are provided in storage zone 16 in a storage building 42.

Compartment rack 44 comprises a plurality of compartments A to E for batteries of several types 8A to 8E as well as a compartment F for flexible use. Testing area 46 is used to test batteries 8 either for release for storage in compartment rack 44, for a request for maintenance or for rejection and removal.

Batteries 8 are connected to a charging system in the compartments of compartment rack 44. For this purpose, the compartments of compartment rack 44 comprise connections which correspond to the poles of batteries 8 and which produce a contact with the latter automatically, preferably in a form-fit manner, in the course of the storage procedure. Batteries 8 are thus charged in compartment rack 44. The charging procedure is carried out automatically with a view to energy efficiency, safety and storage logistics. Permanent compensation charging is avoided on grounds of efficiency.

For safety reasons, compartments A to F of compartment rack are partitioned off from one another with fire protection, optionally also further compartmentalised. Furthermore, the whole of storage zone 16 and the whole region of conveyor 38 and replacement pit 36 are isolated with a tank system against the penetration of liquids possibly emerging from battery 8 into the ground.

In energy management zone 18, a central energy control unit (P-ECU) 48 controls all the procedures inside filling station T and distributes the electric energy via a distribution network 50 to the respective consumers, in particular automatic chargers 24 in charging zone 12, charging connections 40 in replacement zone 14 and the charging system in storage zone 42.

A transformer 52 receives electric energy from remote energy network “N” and converts it into a useful voltage.

Electric energy is buffered in an intermediate storage unit 54. A windmill 56 generates electric current from wind energy by means of a generator “G”.

Windmill 56 is just one example of the local generation of electric energy. Depending on the geographical location, use may also be made of a solar farm, a tidal or wave power installation, a water storage power station, a flow-water generator, a geothermal generator or suchlike, in order to utilise regenerative energy sources. The electricity generated locally from regenerative energy sources is also buffered in intermediate storage unit 54 when it is not immediately consumed, because as a rule it is not continuously available. Apart from regenerative power generation, the system can be provided with its own power station of conventional design.

Finally, a radio device 58 is provided in order to enable communication with an administrative control centre, other filling stations, a satellite network or vehicles (see below).

FIG. 3 shows diagrammatically a configuration of an infrastructure according to the present invention. Vehicle 2, as a representative of a large number of vehicles, is travelling on a road network 1. A large number of filling stations T are set up on road network 1, which are essentially constituted according to the representation in FIG. 2 and the respective description. The infrastructure also includes a satellite 60 of a satellite communication network (which can originate from an external supplier) and an administrative control centre “Z”.

The control device of the vehicle (V-ECU) 10 communicates with radio devices 56 of filling stations T via an aerial 62 of vehicle 2 and aerials 64 of filling stations T. The communication can also take place via satellite 60 serving as a relay. V-ECU 10 and radio device 56 of filling stations T can also communicate with administrative control centre Z via the satellite relay.

FIG. 4 shows the schematic structure of the energy management system of vehicle 2. In particular, battery 8 and vehicle ECU (V-ECU) 10 of the vehicle with one of wheels 4 and associated electric motor 6 as well as a large number of peripheral devices are shown in this figure.

Battery 8 comprises a plurality of storage cells 66 which are connected internally. The negative potential of the battery is earthed via a negative pole 68, the positive potential being connected via a positive pole 70 to vehicle ECU (V-ECU) 10. A battery control unit (Bat-ECU) 72 is constituted in a manner known per se with a CPU, a ROM, a RAM, an internal bus and an I/O bus (the I/O bus is symbolised in the figure by the outer border of Bat-ECU 72). Bat-ECU 72 monitors the voltages of individual cells 66 and performs a charge compensation (balancing). Bat-ECU 72 is also connected to a plurality of temperature sensors “θ”, which pick up the temperature of cells 66, and controls a cooling device 74, which is symbolised in the figure as a fan wheel for the purpose of illustration, but which can have any form of an active and/or passive cooling device.

The CPU of Bat-ECU 10 is connected to an external bus 76, which is also connected to the I/O bus of V-ECU 10. External bus 76 is a vehicle-based bus and is connected to all the electronic devices in the vehicle that require a connection to V-ECU 10.

Vehicle ECU (V-ECU) 10 is also constituted in a manner known per se with a CPU, a ROM, a RAM, an internal bus and an I/O bus (the I/O bus is again symbolised by the outer border of V-ECU 10). It communicates with other electronic devices via its I/O bus, which is connected to external bus 76. V-ECU 10 also comprises an energy control system (CTRL) 78, which is connected to positive pole 70 of battery 8 and electric motors 6 of vehicle 2 and controls the distribution of the electric energy between battery 8 and electric motors 6. In order to differentiate between control, data and measurement lines, the line connections for the transmission of the electric energy of battery 8 are drawn double in the figure.

A driver command unit 80 contains an acceleration pedal and a brake pedal and a steering wheel and outputs the driver commands to external bus 76. A joystick solution can also be provided instead of the conventional operating elements.

Out of the four wheels 4 and electric motors 6, only one is represented in each case in the figure. The electric motor is a motor generator (M/G), which not only drives wheel 4, but can also take up regenerative braking moments. M/G 4 is controlled via external bus 76 from the CPU of V-ECU 10 and monitors and exchanges electric energy via CTRL 78 with battery 8. Electric motor 6 also has a connection to the earth potential. Furthermore, electric motor 6 delivers a speed signal.

The driving control of electric motors 6 essentially takes place on the basis of the signals of driver command unit 80. V-ECU 10 can however also perform ASR, ABS, ESR and other control programs, which are superimposed on the driver commands.

A dashboard 82 is used to display the vehicle and driving statuses by means of circular instruments, pointer instruments, lamps and suchlike, optionally also on a multifunctional display.

An inertia measuring unit (GYRO) 84 detects longitudinal, transverse and vertical accelerations, rolling, yawing and pitching accelerations, as well as longitudinal and transverse inclination of vehicle 2 and delivers these data via external bus 76 to V-ECU 10.

Sensor unit 86, which is representative of a large number of sensors, detects data, in particular weather data concerning the surrounding area of vehicle 2, such as for example temperature, light intensity, humidity, wet conditions, headwind, tailwind, side wind and suchlike and delivers these data via external bus 76 to V-ECU 10.

A communication device (KOMM) 88 is used for communication with supply stations and/or an administrative control centre, on a terrestrial route or a satellite-assisted route. It is connected to aerial 62 and via external bus 76 to V-ECU 10 (see FIG. 3). The communication device can also be integrated in V-ECU 10 itself.

A radio receiver (RADIO) 90 with an aerial 92 is used to receive transmissions from a radio establishment, which can be reproduced by a sound reproduction system (not represented in detail). The transmissions can contain weather measurement data, weather forecast data and traffic data, i.e. data concerning the traffic situation on specific stretches of road. Radio receiver 90 relays these data, optionally after suitable decoding, via external bus 76 to V-ECU 10.

A navigation device (NAVI) 94 comprises an aerial 96 and a display and input unit 98 and is connected via external bus 76 to V-ECU 10. Via aerial 96, data are received from a navigation system such as the example GPS or suchlike, which are used to ascertain the present position. Navigation device 94 comprises a memory unit for storing map data and is capable of ascertaining a travel route from the present position of the vehicle to a destination selectable by a user via display and input unit 98 and displaying the same on display and input unit 98. Driving instructions can also be outputted via the sound reproduction system of the vehicle or an on-board loudspeaker (not represented in detail). Apart from the map data, which encodes the actually existing road network in the form of nodal points and connecting routes, navigation device 94 can also make available in its memory unit extended route data, such as for example height profile, curve characteristics, lateral inclination, road surface and condition, necessary stopping points or stopping points to be expected at intersections, crossroads, traffic lights, level crossings, speed restrictions, traffic density to be expected statistically and so forth, optionally with the inclusion of the date (to take account of days of the week, holidays, public holidays, holiday periods etc.) as well as time of day (to take account of business traffic, start and end of school, etc.).

In the event of failure of the GPS navigation, the output values of inertia measuring unit 84 can be used for chain navigation.

The division of the components in FIG. 4 is made according to aspects of functionality and for illustrative purposes and is to be understood as being by way of example. Aerials 62, 90, 96 can be brought together in a single aerial unit, and a plurality of aerials can also be provided for different frequency ranges or for terrestrial and satellite-assisted communication. Furthermore, parts or the totality of communication unit 88, radio receiver 90, the navigation device, sensor unit 86 and inertia measuring device 82 can also be combined, integrated into V-ECU 10 or be further subdivided.

The mode of operation of the system according to the invention is as follows. A distinction is made between a passive mode of operation and an active mode of operation. The passive mode of operation will first be described.

Bat-ECU 72 ascertains a charge status of battery 8 and transmits it to V-ECU 10. Furthermore, identification data of battery 8, which indicate the type of battery 8, are stored in Bat-ECU 72. In addition, a unique identification number, charging and discharging characteristics and suchlike can also be stored there, which when required are also transmitted to V-ECU 10.

V-ECU 10 calculates the current range of the vehicle from the charge status of battery 8 and transmits the result to navigation device 94.

By means of navigation device 94, a current position of the vehicle is ascertained and transmitted to V-ECU 10. (An exchange of data between components 6, 10, 72, 80, 82, 84, 86, 88, 90 and 94 takes place via external bus 76, even though this is not explicitly pointed out each time.) Furthermore, a travel destination is inputted via a display and input unit 98 of navigation device 94. The navigation device determines a travel route from the present position of the vehicle and displays it on display and input unit 98.

Data concerning a large number of filling stations T are stored in navigation device 94. These data contain the position of filling stations T in the road network, the number and type of charging stations 24, 40 and replacement stations 14, battery types A-E held in stock and suchlike (see FIG. 2). The data can be regularly updated in the form of subscribed data carriers such as, for example, CD-ROMs or DVD-ROMs or memory cards or sticks, by downloading or other methods. By matching with the identification data of battery 8, it is known which of the filling stations are equipped for recharging and/or for replacement of battery 8 carried on board the vehicle. From these filling stations, navigation device 94 selects as suitable one or more filling stations which lie within the calculated range of the vehicle and displays the latter on input and display unit 98. In principle, all the filling stations lying within the range of the vehicle can be selected or only those that meet additional, preselected criteria and/or criteria selectable via display and input unit 98. The following can be used as additional criteria to indicate whether a filling station is suitable:
whether the filling station lies in the direction of the inputted destination as the crow flies;
whether the filling station lies on the calculated travel route;
whether the present range of the vehicle will be used in the optimum manner on the journey to the filling station (i.e. the filling station, taking account of a suitable safety reserve, lies at the end on the calculated travel route, but within the range of the vehicle);
whether the filling station has a replacement station and is holding the required type of battery in stock (primary preference);
whether the filling station has a charging station equipped for quick charging (secondary preference);
whether the filling station has visitor facilities;
whether the filling station offers accommodation, and so forth. The route calculation takes place iteratively, in such a way that the calculated travel route always leads via suitable filling stations. (In the case of longer distances which require repeated battery replacement or repeated charging, the calculation of the range from the given filling station is in each case made on the basis of a full battery charge, taking account of suitable safety margins.)

The filling stations are weighted according to their suitability and are displayed differently on input and output unit 98 according to the degree of suitability. In addition, filling stations T determined as suitable are highlighted along the calculated or selected travel route on input and output unit 98 of navigation device 94, and more precisely those that lie within the range separately from those that lie outside the range. Filling stations that lie off the calculated or selected travel route are also displayed differently according to their reachability, but differently from those lying on the travel route. The driver of vehicle 2 is thus able to observe the availability of suitable filling stations in the surrounding area of his travel route and to assess their reachability.

Filling stations can also be offered to the user for selection or rejection. Specific filling stations regarded by the user as unsuitable for individual reasons can thus be eliminated from the route calculation. A suitable travel route can thus be calculated iteratively by repeatedly performing the filling station determination, selection/rejection and the route calculation.

In the passive mode of operation described hitherto, no communication procedures—apart from the signal transmission procedures with a satellite navigation network to ascertain the present position of the vehicle—were necessary to carry out the route-finding via suitable filling stations.

In a further, active mode of operation, it is possible to increase still further the supply reliability and planning reliability of journeys with an electric vehicle.

In the active mode of operation, a wireless, terrestrial or satellite-supported data exchange between the vehicle (i.e. V-ECU 10) and a network of operators of filling stations and the ascertainment of the stock levels of batteries of different types at the filling stations and their charge statuses takes place, and the suitability or non-suitability of a filling station is determined on the basis of the number and the charge status of batteries of the required type. In principle, suitability is recognised only if a sufficient number of batteries of the required type in a fully charge state is available in the storage facility of the filling station (exceptions described below). In the case of some battery types, the fully charged state is already reached below the theoretically possible charge, e.g. at 90%.

The network comprises filling stations T and, as appropriate, an administrative control centre Z (see FIG. 3) as well as vehicles 2 which are participating in the system. It is in principle irrelevant for the applicability of the present invention which entity determines the suitability or non-suitability of a filling station T for a vehicle 2. The decisive factor is that the determining entity is informed about the number and charge status of the batteries at least of the required type at filling station T concerned and about the present position and range of vehicle 2 involved.

In a basic mode of operation, a vehicle 2 transmits information concerning the position, range, battery type and charge status via communication device 88 to a filling station T within radio range or via a satellite relay 60 to an administrative control centre Z (see FIG. 3), which for its part transmits the data via satellite relay 60 or via an—optionally wire-bound—fixed network to filling station T. The data can also be broadcast to a plurality of filling stations within a reasonable area surrounding vehicle 2. Filling stations T to which the data are to be sent can be selected, for example, by administrative control centre Z on the basis of the battery type of battery 8 and its maximum or current range. The data are received by filling station T in communication device 58, and it is ascertained in P-ECU 52 or a specialised control unit of storage zone 16 how many batteries of the required type are present, and whether they are available fully charged. The batteries that are still being charged can also be taken into account, but must have been fully charged by the time of the expected arrival of vehicle 2. The number and the charge status of the batteries in filling station T are transmitted as information via communication device 58 either directly or via satellite relay 60, optionally with the interposition of administrative control centre Z, to vehicle 2. This information is received in communication device 88 of vehicle 2 and is stored in V-ECU 10 and further processed. In particular, the information for determining the suitability or non-suitability of the filling station is used.

In a variant, data relating to the travel route are also transmitted from vehicle 2, and the suitability or non-suitability is determined individually for the vehicle by filling station T, and the data transmitted from filling station T contain only the information as to whether filling station T is suitable or not.

In a control-centre operating mode, data concerning the stock levels at all filling stations T of the system are constantly transmitted to administrative control centre Z. Data concerning battery type, position and range, optionally also travel route data and further information of the vehicles moving in the system, are also constantly transmitted to administrative control centre Z. The suitability or non-suitability of filling stations T for vehicles 2 is constantly recalculated in administrative control centre Z and data containing this information are transmitted to vehicles 2. In this way, the computational burden for calculating the suitability or non-suitability of filling stations in the system is transferred to administrative control centre Z, and vehicle 2 or its navigation device 94 merely has to calculate the travel route, taking account of the information concerning suitable filling stations.

In a radio transmission operating mode, all filling stations T transmit the data concerning the stock level with a given transmission power via a radio device 58 and its aerial 64 in the manner of a radio transmission, and the data are received by all the vehicles that are located in the area surrounding the filling station determined by the transmission power. The vehicle then determines which of the filling stations are suitable or not.

The computational burden can also be distributed in a different way and can expediently be optimised on the basis of criteria such as operational safety, data protection, computational burden, memory requirement, current consumption etc.

In a reservation operating mode, an advance notice and reservation of one or more batteries at a filling station T takes place. This is because the situation may arise where a vehicle, to which an adequate stock of batteries of the required type has been communicated by a filling station T, finds when it arrives that none of the required batteries is available there, because they have been claimed in the meantime by other vehicles. In order to avoid such as a situation, vehicle 2 sends a reservation request to a selected filling station T. The selection is made either by the driver of vehicle 2 via display and input unit 98 of navigation device 94 or automatically by V-ECU 10, if there is only still one suitable filling station T present on the selected travel route. Before the placing of an automatic reservation order, a confirmation can be obtained by the driver. Advance notice of the requested batteries then takes place in P-ECU 48 of filling station T. The batteries for which an advance notice has been received are no longer taken into account in the ascertainment of the stock level; nor are they released for issue to another vehicle. After a further confirmation of the advance notice, the reservation of the respective batteries then takes place at filling station T. The driver of vehicle 2 can therefore be sure that he will find the required number of fully charged batteries of the required type when he arrives at filling station T.

If it should happen that a reserved battery is not claimed, for example because driver 2 has already carried out a replacement at an earlier filling station T or has passed by filling station T without carrying out a replacement of the battery, a communication takes place to cancel the reservation. Before the cancellation is carried out, a confirmation from the vehicle concerned or driver concerned is obtained; in addition, the initiation of the communication for the cancellation of a reservation takes place only when the vehicle has a range which reliably reaches a more distant suitable supply station. A cancellation can also take place automatically after a certain time has passed since the reservation was made.

The reservation and cancellation takes place completely automatically in an automated operating mode, i.e. without confirmation by the driver. The driver is merely informed and directed to the filling stations at which a reservation has been made. Especially when the supply station is the only reachable suitable supply station for the vehicle in the course of the travel route, the reservation is made irrespective of a confirmation by a user.

The system is also equipped, with regard to reservations, to take account of the actual requirement of the other traffic participants. Thus, when reservation requests are being considered, there is a prioritisation of enquiries from vehicles with a smaller current range compared to requests from vehicles with a greater current range. In particular, requests from vehicles which can only just reach the replacement station where the request has been made are prioritised over requests from vehicles which can still reach more distant replacement stations. When a request is received from a vehicle which can only just reach the replacement station at which a request has been made, reservations for vehicles which can reach more distant replacement stations can also be automatically cancelled. The vehicle whose reservation has been cancelled is then directed to another suitable filling station.

The procedures for reservation and cancellation can also be carried out centrally in a computing unit of administrative control centre Z. An operating mode controlled in a completely centralised manner is also provided, in which the travel routes of all the vehicles participating in the method are managed dynamically on the basis of the routes defined by the starting point and destination and selected and notified previously by the given user, in such a way that the travel time and/or the total energy consumption of the vehicles are optimised. The drivers of the vehicles can manually select participation in this operating mode.

The calculation of the range of a vehicle 2 with an electric power unit 8 is now dealt with in greater detail.

When the range is calculated on the basis of the charge status, it may be sufficient, for example on a flat stretch of road without any significant obstructions, to take the average range at the usual travelling speed as a basis. In addition, a correlation between charge statuses and average ranges can be made available in the form of a simple table, for example in a memory of a data processing device that implements the method.

In practice, however, the energy consumption depends on many factors. Consequently, diverse information in respect of the vehicle, the driver, the stretch of road and external influences are taken into account when calculating the range, in order to obtain an appropriate estimate adapted to the given situation on the one hand and to be able to take sufficient safety margins into account on the other hand.

In order to calculate the range, therefore, the current measured speed of the vehicle is first taken as a basis, which is obtained from initial values of a speed sensor on wheel 4 (optionally a mean value of the initial values of speed sensors of a plurality or all of wheels 4), or from initial values of angle transducers on electric motors 6. A speed profile is also stored, in other words a course of the speed of the vehicle measured and stored since the time of the last stop or since a time selectable by the user, which permits conclusions to be drawn about the driving behaviour of the driver and therefore about the energy consumption to be expected in the future. Speed profiles of the driver from past journeys and/or empirical values concerning speed profiles already travelled in the past in specific sections of the road can also be used.

Furthermore, a desired driving mode (sporting, fast, economical or suchlike) can be preselected by the driver and the speed and/or acceleration ranges stored in this regard can be retrieved. The data thus obtained permit an extrapolation of the speed profile to be expected during the subsequent journey and therefore the energy consumption to be expected.

The energy consumption of vehicle 2 is also dependent on unchanging vehicle parameters such as for example rolling resistance coefficient, drag coefficient, suspension properties and weight, preferably taking account of a currently measured additional load or one that has previously been inputted by a user, but also on motor load characteristics (defined for example as current consumption or efficiency of the motor depending on the torque and speed) and the battery discharge characteristics (defined for example as charge loss of the electric power unit as a function of current and voltage). Such values are stored in the ROM of V-ECU 10 and Bat-ECU 72 and can be retrieved to calculate the range of the vehicle.

The energy consumption is also decisively influenced by the course of the road on a travel route, in particular height profile (inclines and gradients), curve characteristics, lateral inclination, road surface and condition, speed restrictions, traffic density to be expected statistically, necessary stopping points or stopping points to be expected at crossroads, intersections, traffic lights, level crossings and suchlike. Such data are stored, optionally taking account of the day of the week, public holidays, holiday periods and the time of day etc., in a memory of navigation device 94 and are made available by administrative control centre Z upon request through V-ECU 10 and are also used to calculate the energy consumption. These data can be refined on the basis of traffic situation information in the surrounding area of the vehicle and/or along the expected travel route, which are received by a radio device 90 from a radio transmitter or via communication device 88 from administrative control centre Z.

Furthermore, the energy consumption is influenced by the weather situation, in particular by wind strength and direction, but in addition temperature and rainfall or wet conditions can influence, for example, the rolling resistance of the wheels or the battery discharge characteristics. In order to calculate the energy consumption, therefore, use is also made of general statistical weather forecast values, which are stored in the memory of navigation device 94, weather forecast values and weather data, which are received via a radio device 90 from a radio transmitter or via communication device 88 from administrative control centre Z, as well as measured values from sensor unit 86.

If the vehicle is equipped with solar modules for photovoltaic power generation, the charging of battery 8 by photovoltaically generated current can also be taken into account when ascertaining the range of vehicle 2. In order to extrapolate into the future, recourse can be taken to the aforementioned weather data, in particular with regard to brightness, cloudiness, rainfall or fog, and the time of day.

In order to calculate the range, a plurality of alternative speed profiles can also be extrapolated on the basis of varied parameters. In particular, the user can be given a specific speed profile that is to be adhered to if a specific filling station is to be reached. The alternative speed profiles are presented to the driver for selection.

Route finding, taking account of suitable filling stations, is continuously repeated during the journey in the form of a loop. If it emerges that, contrary to earlier calculation results, the reaching of a suitable filling station could be problematic (whether it be due to an unexpectedly high energy consumption or unexpected business at the filling stations), the driver is warned. Depending on the set level of automation, further countermeasures are taken, including specific calculations of variations and suggestions for action. In the first place, alternative travel routes and speed profiles are calculated, with which the filling station can still be reached. It may thus be possible to dispense with a specific extreme speed and acceleration range. This can take place as a suggestion for action or also in the form of an automatic restriction or capping. As the next step, alternative supply stations are determined that can still be reached. If need be, the criterion of sufficient stock levels can be dispensed with if the filling station has a quick charging device or, if such a filling station is also no longer reachable, a filling station with a straightforward charging facility can be selected. In the latter case, preference is given to the filling stations which have catering and/or accommodation facilities. In case of emergency, only partially charged batteries are also used to determine the suitability of a filling station T if better suited filling stations are available on the subsequent route. If the vehicle has a manual drive support (the initially mentioned TWIKE, for example, can be obtained with an optional auxiliary pedal drive device), the countermeasures can also include the suggestion to use the manual drive support continuously or on certain sections of the route (for example on inclines or against a headwind).

Battery 8 is an electric power unit within the meaning of the invention. The invention, however, can be applied to any exchangeable unit which makes energy of any energy carrier available for driving the vehicle. The route finding procedure can even be used for vehicles with internal combustion engines. It is always advisable to use it when the availability of the energy carrier for driving the vehicle is scarce, i.e. the supply situation at individual filling stations is questionable.

Filling stations T are supply stations within the meaning of the invention.

The invention can also be advantageously used with an electrically driven boat on inland waters or in sea areas close to the coast. Here too, supply stations at boat mooring points or service points or suchlike communicate by radio with a V-ECU directly with the Bat-ECU, which is equipped for this purpose with its own communication device, and exchange information concerning the charge status of the battery and the stock level at the mooring point. The procedures are adapted to the aspects of importance in navigation. Thus, when the range is being calculated, instead of specific aforementioned parameters limited in some cases to land-based vehicles, other parameters are used, such as for example current resistance, propeller efficiency, current direction and speed and suchlike. Safety margins are, if necessary, dimensioned more generously with weather variations which are known to be unpredictable. As a manual drive support, a rudder drive or an auxiliary sail arrangement is conceivable in the case of boats. Such an embodiment of the invention is described with the aid of FIGS. 5 and 6.

FIG. 5 shows a battery 8′ of this embodiment in a perspective representation. In the example of embodiment described here, battery 8′ forms the energy source of a drive motor for a boat.

Disposed in a holding fixture 100 are four storage blocks 102, which are each constituted by a plurality of galvanic cells (not represented in detail), and which are connected to one another in a suitable manner. The total output voltage of battery 8′, i.e. storage blocks 102 connected together, is present as poles 104 and 106, which are provided on holding fixture 100.

Each storage block 102 comprises a control device (block ECU) 108, which is connected to the interior by means of cabling 110. Via block ECUs 108, a balancing, i.e. a charge equalisation between the cells inside a block 102, is for example carried out.

Block ECU's 108 are connected to a common control device (Bat-ECU) 112, which is responsible for the overriding control of all storage blocks 102. In particular, all the data concerning the charge status of storage blocks 102 run together in Bat-ECU 112. Bat-ECU 112 is provided with an aerial 114, via which signals are received from satellites of a navigation system such as, for example, GPS. Bat-ECU 112 performs a position determination on the basis of these signals. Via aerial 114, Bat-ECU 112 also carries out a communication with supply stations. In particular, Bat-ECU 112 receives stock level data from supply stations via aerial 114. Similar to the cases described above, Bat-ECU 112 can also transmit, via aerial 114, charge status data and positional data to the supply stations or an administrative control centre.

Furthermore, Bat-ECU 112 is connected to a user interface 116. User interface 116 comprises a display screen 118 and a plurality of input keys 120. The boat with a marking B inside a stretch of water G is displayed on display screen 118. (In the representation selected here, the whole stretch of water is displayed on the display screen; alternative magnification and reduction stages can also be selected via input keys 120. A compass indicator K indicates a northerly direction, whilst a wind indicator W indicates the present wind direction. (Devices such as for example sensors or suchlike for ascertaining the northerly direction and the wind direction are not represented in detail).

Represented on the shore of stretch of water G are seven supply stations V1 to V7 which are equipped for the replacement of battery 8′. In the situation represented, supply stations V1, V2, V3, V5 and V7 are represented by a filled-in dot; this signifies that Bat-ECU 112 has ascertained that these supply stations can be reached with the present battery charge status and taking account of the wind direction. Of these reachable supply stations, supply stations V1, V3, V5 and V7 are marked by a surrounding circle; this means that Bat-ECU 112 has ascertained on the basis of the stock levels communicated by the supply stations that a replacement of battery 8′ with a charged battery is possible there. In contrast, supply stations V4 and V6 are represented merely by an empty dot; these supply stations cannot currently be reached.

By means of input keys 120, the user has the option, on the one hand, of changing the display on display screen 118 and, on the other hand, of making the inputs for the calculation of the reachability. It is thus possible, for example, to input the fact that only the supply stations are to be taken into account that can be reached at full speed ahead (for example, because a storm is building up), or also those are to be taken into account that can also be reached at half speed ahead or slow speed ahead.

The invention has been described above on the basis of specific examples of embodiment. An urban system or one that can be used on inland waters to cover individual mobility on the basis of chargeable and/or replaceable power units is implemented with the invention. The system is particularly suitable for exchangeable electric battery blocks, wherein a unit can comprise one or more structurally coupled blocks.

The method for the dynamic determination of a travel route is generally suitable for vehicles, irrespective of the type of energy carrier. It describes a mode of operation of a navigation system, wherein the power supply on board the vehicle and the availability of suitable supply stations are incorporated into the route finding.

### LIST OF REFERENCE NUMBERS

1 road network
2 vehicle
4 drive wheel
6 electric motor (M/G)
8, 8′ (storage) battery
10 vehicle control device (V-ECU)
12 charging zone
14 replacement zone
16 storage zone
18 energy management zone
20 approach path of 12
22 charging place
24 automatic charger
26 approach path of 14
28 service pylon
30 automatic service machine
32 replacement place
34 standing track
36 replacement pit
38 conveyor
40 charging connection
42 storage building
44 compartment rack
46 testing area
48 energy control unit (P-ECU)
50 distribution network
52 transformer
54 intermediate storage unit
56 windmill
58 radio device
60 satellite
62 aerial of 2 or 88
64 aerial of T or 58
66 storage cell of 8
68 negative pole
70 positive pole
72 battery control unit (Bat-ECU)
74 cooling device
76 external bus
78 energy control system (CTRL)
80 driver command unit
82 dashboard
84 inertia measuring unit (GYRO)
86 sensor unit
88 communication device (KOMM)
90 radio receiver (RADIO)
92 aerial of 90
94 navigation device (NAVI)
96 aerial of 94
98 display and input unit
100 holding fixture of 8′
102 storage block
104,106 poles
108 block-ECU
110 cabling
112 Bat-ECU
114 aerial of 112
116 user interface
118 display screen
120 input key
B boat
G generator; stretch of water
K compass indicator
N remote energy network
P present position
S starting point
T filling station
V1, V2 supply stations
W wind direction indicator
Z destination

It is expressly pointed out that the above list of reference numbers forms part of the description.

1. A method for operating a vehicle, which comprises an electric travel drive and at least one rechargeable and replaceable electric power unit, wherein electric drive energy is fed from the electric power unit to the electric travel drive and wherein the electric power unit is charged or replaced when its charge status is low, comprising the following steps:
determination of a charge status of the electric power unit;
determination of a current position of the vehicle;
calculation of a range of the vehicle on the basis of the charge status of the electric power unit;
determination of a given stock level of supply stations which are equipped for the recharging and/or the replacement of the electric power unit, wherein the stock level is defined at least by the number and charge status of electric power units held in stock in a supply station; and
determination of at least one of the supply stations as a suitable supply station, if the supply station lies within the range of the vehicle and the stock level of the supply station meets a predetermined condition, in particular a predetermined number of charged electric power units are available for replacement,
wherein, in order to calculate the range and/or to determine suitable supply stations, essential data are communicated between the vehicle and at least one of the supply stations and/or between the vehicle and a control centre and/or between the supply stations and the control centre, wherein at least the communication between the vehicle and the supply stations and/or the control centre takes place in a wireless manner.

2. The method according to claim 1, further characterised by a step of broadcasting at least the position and the present range of the vehicle, and a step of transmitting information concerning suitable supply stations to the vehicle.

3. The method according to claim 1 or 2, further characterised by a step of broadcasting the stock level of a supply station within a predetermined surrounding area.

4. The method according to any one of the preceding claims, characterised in that a supply station, when the stock level of the supply station does not meet the predetermined condition, is alternatively designated as a suitable supply station if it is equipped to charge the electric power unit with a quick-charging procedure.

5. The method according to claim 4, characterised in that a supply station, when the stock level of the supply station does not meet the predetermined condition and is not equipped for charging the electric power unit with a quick-charging procedure, is designated alternatively as a suitable supply station if it is in principle equipped for charging the electric power unit, wherein such a supply station is preferably taken into account if it lies at the destination of the journey.

6. The method according to any one of the preceding claims, characterised in that a destination selectable by the user is taken as a basis for the determination as a suitable supply station or the supply stations determined as suitable are weighted on the basis of the selected destination.

7. The method according claim 6, characterised in that the suitable supply station located farthest from the present position of the vehicle in the direction of the destination is determined as the target supply station, taking account of a predetermined safety reserve.

8. The method according any one of the preceding claims, further characterised by a step of calculating a travel route from the present position of the vehicle to the destination on the basis of suitable supply stations.

9. The method according to claim 8, characterised in that the suitable supply station located farthest from the present position of the vehicle on the calculated travel route is determined as the target supply station, taking account of a predetermined safety reserve.

10. The method according to any one of the preceding claims, further characterised by a step of offering suitable supply stations on the travel route for selection or rejection by the user.

11. The method according to any one of the preceding claims, characterised in that the steps of calculating a travel route and determining suitable supply stations, preferably including the step of determining a target supply station and the step of offering and selection or rejection, are carried out iteratively.

12. The method according to any one of the preceding claims, characterised by a step of reserving a required number of electric power units for a vehicle, if a supply station has been determined as a suitable supply station for this vehicle, especially in response to a request by the vehicle, wherein the request preferably requires a confirmation by a user of the vehicle.

13. The method according to claim 13, characterised in that the reservation takes place regardless of a confirmation by a user, if the supply station is the only reachable, suitable supply station for the vehicle.

14. The method according to claim 13 or 14, characterised in that requests are prioritised taking account of the range of the vehicles making the requests.

15. The method according to any one of claims 13 to 15, characterised by a step of cancelling a reservation, if the vehicle for which the reservation has been made does not claim the reservation.

16. The method according to any one of the preceding claims, characterised in that the range is calculated on the basis of at least one currently measured speed of the vehicle or a previous speed profile or from energy consumption parameters of the vehicle or from driver behaviour data or from travel route parameters or from weather information or from traffic information.

17. The method according to any one of the preceding claims, characterised in that the range is calculated on the basis of a future speed profile extrapolated from the previous speed profile.

18. The method according to any one of the preceding claims, characterised in that a plurality of alternative speed profiles are extrapolated on the basis of varied parameters to calculate the range.

19. The method according to any one of the preceding claims, characterised in that the establishment of the suitability or non-suitability of a supply station is repeated continuously during the journey of the vehicle.

20. The method according to claim 20, further characterised by a step of continuously checking whether a suitable supply station can be reached on the currently adopted travel route and, if this is not the case, taking countermeasures which at least comprise the output of a warning.

21. The method according to any one of the preceding claims, characterised in that the steps of the method are carried out distributed so as to be undertaken by the vehicle, by one or more supply stations and/or by an administrative control centre.

22. The method according to claim 22, characterised in that the travel routes of all the vehicles participating in the method are conducted dynamically on the basis of the routes previously selected and notified by the given user and defined by starting point and destination, in such a way that the travel time and/or the total energy consumption of the vehicles are optimised.

23. A navigation device for carrying on board a vehicle, which is equipped for the performance of the method according to any one of the preceding claims by the vehicle.

24. A vehicle energy control system for controlling an energy supply for a vehicle, which comprises an electric travel drive and at least one rechargeable and replaceable electric power unit, wherein electric drive energy is fed from the electric power unit to the electric travel drive and wherein the electric power unit is recharged or replaced when its charge status is low, comprising
a position locating device for locating a position of the vehicle;
a charge status determination device for determining a charge status of the electric power unit;
a range calculation device for calculating a range of the vehicle on the basis of the charge status of the electric power unit determined by the charge status determination device;
a reception device for the wireless reception of information from a wireless remote communication network concerning supply stations which are equipped for the charging and/or the replacement of the energy storage unit and concerning their given stock level, wherein the stock level is defined at least by the number and charge status of electric power units held in stock in a supply station; and
a suitability determination device for determining a supply station as a suitable supply station when the supply station lies within the range of the vehicle and its stock level meets a predetermined condition, in particular such that a predetermined number of charged electric power units is available for replacement.

25. The vehicle energy control system according to claim 25, further characterised by a transmission device for the wireless transmission of information containing the position and the range to a remote communication network,
wherein the received information contains information concerning supply stations which are within the range of the vehicle, either exclusively or in a specially characterised form.

26. The vehicle energy control system according to claim 26, further characterised by a memory device, in which identification data of the electric power unit and preferably of the vehicle, and/or charging/discharging parameters of the electric power unit and preferably energy consumption parameters of the vehicle are previously stored;
wherein the transmitted information additionally contains identification data of the electric power unit and optionally of the vehicle, the charging/discharging parameters of the electric power unit and the energy consumption parameters of the vehicle, and
wherein the received information concerning stock levels only contains information concerning stock levels of electric power units of a type which corresponds to the type of the electric power unit carried on board the vehicle.

27. A vehicle energy control system for controlling an energy supply for a vehicle, which comprises an electric travel drive and at least one rechargeable and replaceable electric power unit, wherein electric drive energy is fed from the electric power unit to the electric travel drive and wherein the electric power unit is recharged or replaced when its charge status is low, comprising:
a memory device, in which identification data of the electric power unit and preferably of the vehicle, and/or charging/discharging parameters of the electric power unit and preferably energy consumption parameters of the vehicle are previously stored;
a position locating device for locating a position of the vehicle;
a charge status determination device for determining a charge status of the electric power unit;
a transmission device for the wireless transmission of information, which contains the position, the charge status of the electric power unit, the identification data of the electric power unit and optionally of the vehicle, the charging/discharging parameters of the electric power unit and the energy consumption parameters of the vehicle, to a remote communication network; and
a reception device for the wireless reception of information from the remote communication network concerning the present range of the vehicle and concerning supply stations which are within the range of the vehicle and which are equipped and suitable for the charging and/or the replacement of the electric power unit, wherein only the supply stations are determined as suitable whose stock level meets a predetermined condition, in particular such that a predetermined number of charged electric power units are available for replacement.

28. The vehicle energy control system according to any one of claims 25 to 28, further characterised by a navigation system for ascertaining a travel route from the present position of the vehicle to a destination selectable by the user, wherein the navigation device preferably makes available route data, such as height profile, curve characteristics, lateral inclination, road surface and condition, speed restrictions, traffic density to be expected statistically, necessary stopping points or stopping points to be expected, optionally taking account of the day of the week, the date and/or the time of day.

29. The vehicle energy control system according to any one of claims 25 to 29, further characterised by a traffic information evaluation device for receiving and evaluating traffic information, which is made available by an administrative control centre or a radio transmitter.

30. The vehicle energy control system according to any one of claims 25 to 30, further characterised by a weather information evaluation device for receiving and evaluating weather information, which is made available by an administrative control centre or a radio transmitter.

31. The vehicle energy control system according to any one of claims 25 to 31, further characterised by a weather data detection device for detecting weather data such as temperature, light intensity, humidity, wet conditions, headwind, tailwind, side wind and suchlike.

32. The vehicle energy control system according to any one of claims 25 to 32, further characterised by a driving state detection device for detecting characteristic driving states such as speed, longitudinal acceleration, longitudinal deceleration, lateral acceleration, road adhesion or skidding and suchlike.

33. The vehicle energy control system according to claim 33, further characterised by a driving state memory device for storing the characteristic driving states over the course of time.

34. The vehicle energy control system according to claim 34, further characterised by a driver behaviour evaluation device for determining parameters for describing typical driving behaviour of the present driver on the basis of the characteristic driving states in the course of time.

35. The vehicle energy control system according to any one of claims 29 to 35, characterised in that the transmission device is equipped to transmit, to the administrative control centre and/or the supply stations, route data made available by the navigation device and/or traffic information received from the traffic information evaluation device and/or weather data received from the weather information evaluation device or detected by the weather data detection device and/or driving states detected by the driving state detection device and/or driving state characteristics stored in the driving state memory device and/or behaviour parameters determined by the driver behaviour evaluation device.

36. A supply station for supplying with the electric energy vehicles which comprise an electric travel drive and at least one rechargeable and preferably replaceable electric power unit, comprising:
a storage facility for storing a plurality of electric power units;
at least one replacement device for replacing electric power units located on board a vehicle with electric power units from the storage facility;
at least one charging device for charging electric power units located on board a vehicle;
a stock level determination device for determining a stock level of the supply station, defined by the number and charge status of the electric power units stored in the storage facility; and
a communication device for exchanging data with vehicles in the surrounding area of the supply station and/or, via vehicles in the surrounding area of the supply station, with an administrative control centre.

37. The supply station according to claim 37, characterised in that the supply station is equipped for handling a number of types of electric power unit.

38. The supply station according to claim 37 or 38, characterised in that the communication device is equipped to transmit data indicating the stock level to the vehicles or the administrative control centre.

39. The supply station according to claim 39, characterised in that the communication device is equipped to transmit data indicating the stock level only when it receives a stock-level request from a vehicle or the administrative control centre.

40. The supply station according to any one of claims 37 to 40, further characterised by a suitability determination device for determining whether the supply station is suitable for the supply of a vehicle on the basis of the ascertained stock level and the data concerning the vehicle received via the communication device, wherein the received data contains at least a position of the vehicle and a charge status of the electric power unit located on board the vehicle, and by the fact that the communication device is equipped then to transmit data indicating the determined suitability or non-suitability of the supply station to the vehicles or to the administrative control centre.

41. The supply station according to any one of claims 37 to 41, further characterised by a reservation device for reserving an electric power unit for a specific vehicle when it is requested.

42. The supply station according to any one of claims 37 to 42, further characterised in that at least one charging device suitable for quick-charging is present.

43. The supply station according to any one of claims 37 to 43, further characterised by a storeroom charging device for the charging or charge regeneration of electric power units stored in the storage facility.

44. The supply station according to any one of claims 37 to 44, further characterised by an electric energy generation device for generating electric energy from fossils or reproductive raw materials or regenerative sources and preferably an electric energy intermediate storage unit for the intermediate storage of the generated electric energy until its use.

45. An infrastructure for the supply of electric energy to vehicles which comprise an electric travel drive and at least one rechargeable and preferably replaceable electric power unit, comprising
a plurality of the supply stations according to any one of claims 37 to 45; and
a plurality of vehicle energy control systems according to any one of claims 25 to 36,
wherein the supply stations and the vehicle energy control systems are equipped to perform, interacting with one another, a method according to any one of the preceding claims.

46. The infrastructure according to claim 46, further characterised by an administrative control centre, wherein the administrative control centre, the supply stations and the vehicle energy control systems are equipped to perform, interacting with one another, a method according to any one of the preceding claims.

47. A rechargeable and replaceable electric power unit for supplying a vehicle with electric drive energy, comprising a control unit for detecting and controlling operational states, including at least a charge status of the electric power unit, and a radio communication device for communicating with an entity outside the vehicle.

48. The electric power unit according to claim 48, characterised in that the control unit is equipped for storing information, which enables the identification at least of the type of electric power unit, preferably also an assignment to the vehicle carrying the electric power unit on board.

49. The electric power unit according to claim 48 or 49, characterised in that the control unit is equipped for determining the present position of the electric power unit or for evaluating the positional data of a navigation device carried on board the vehicle.

50. The electric power unit according to any one of claims 48 to 50, characterised in that the control unit is equipped for the performance of the method according to any one of claims 1 to 23 by the vehicle.

51. The electric power unit according to any one of claims 48 to 51, characterised in that the radio communication device is equipped for direct communication with the radio communication devices of another electric power unit.

52. The electric power unit according to any one of claims 48 to 52, characterised in that it is a battery based on an electrochemical reaction, in particular with the participation of lithium.
